(19) United States
(12) Patent Application Publication
(10) Pub. No.: US 2016/0215903 A1
(43) Pub. Date: Jul. 28, 2016

(54) IMPROVEMENTS IN AND RELATING TO PIPE CLIPS AND SUPPORTS

(71) Applicant: JCCO 330 LIMITED, Manchester (GB)

(72) Inventor: Paul Davidson, Macclesfield (GB)

(21) Appl. No.: 14/916,455

(22) PCT Filed: Jul. 23, 2014
(86) PCT No.: PCT/GB2014/052252

§ 371 Date: Mar. 3, 2016

(30) Foreign Application Priority Data
Sep. 3, 2013 (GB) 1315663.3

(51) Int. Cl. F16L 3/10; F16L 3/11

(52) U.S. Cl. CPC F16L 3/1025; F16L 3/11

(57) ABSTRACT

Improvements in and relating to Pipe Clips and Supports Disclosed is a pipe attachment (100), comprising first and second elements (110, 120), each comprising an inner sub-element (122) and an outer sub-element (121), the inner and outer sub-elements being rotatable relative to each other, wherein in a first configuration, the first and second elements are separate and positionable to surround the pipe, and in a second configuration, they are locked together, wherein the locking together is achieved by relative rotation of the respective inner and outer sub-elements such that the inner sub-element of the first element at least partially engages with the outer sub-element of the second element, and the inner sub-element of the second element at least partially engages with the outer sub-element of the first element.

The present invention relates to clips and supports for use with pipes. Pipes are frequently fitted in situations where they are hung from a ceiling or surface, and clips are used to surround the pips at intervals, the clips being coupled to the ceiling or to a rail system attached to the ceiling.

FIG. 8 shows a prior art pipe clip 300, which comprises a pair of substantially semi-circular members 310, 320 arranged to surround the pipe and sized according to the external diameter of the pipe. Extending from each end of each semi-circular member is a short flange 330, said flanges arranged to abut when the members are positioned around the pipe. Each flange is provided with a through hole, which serves to accept a fastening 340, which secures the members around the pipe. In the example shown, one or both of the through holes is threaded and the fastening is provided in the form of a screw which couples with the thread.

At the top, in use, of member 310 is a threaded coupling 315 which is arranged to receive a length of complementary threaded rod which is screwed into coupling 315 at one end and into a similar coupling provided on the ceiling or rail system, so that the pipe to which the clip is attached can be suspended from the ceiling.

Prior art clips of the type shown in FIG. 8 are commonly used, but are awkward to fit in situ, as the operative fitting them is working above his head and screws and fittings are frequently dropped.

In such suspended pipe systems and other pipe systems where pipes are run along brackets, or similar fittings, on a wall, it is often desired to attach other items to the exterior of the pipes. Such items might include insulation for pipes which are required to be protected from extremes of temperate or which carry hot liquids and where it is desired to minimise temperature loss along the length of the pipe. Other items which might be fitted include cables which can conveniently follow the path of the pipes, but which require secure attachment thereto. It may be desirable to attach signs or indicators to pipes to indicate what they are carrying and which direction the fluid is flowing etc.

Embodiments of the present invention aim to address these and other shortcoming in the prior art, whether mentioned herein or not.

According to the present invention there is provided a pipe attachment, comprising first and second elements, each comprising an inner sub-element and an outer sub-element, the inner and outer sub-elements being rotatable relative to each other, wherein in a first configuration, the first and second elements are separate and positionable to surround the pipe, and in a second configuration, they are locked together, wherein the locking together is achieved by relative rotation of the respective inner and outer sub-elements such that the inner sub-element of the first element at least partially engages with the outer sub-element of the second element, and the inner sub-element of the second element at least partially engages with the outer sub-element of the first element.

Preferably, the inner sub-element is retained within a channel in the outer sub-element. The channel is shaped to match closely the cross-sectional shape of the inner sub-element.

Preferably, the first element is provided with coupling means arranged for attachment to a support system.

Preferably, the coupling means comprises a boss having a threaded interior for coupling to a complementarily threaded rod.

Preferably, the inner sub-element is provided with an axially extending tab for facilitating the relative rotation of the inner and outer sub-elements.

Preferably, the inner sub-element is provided with a recess arranged to receive a wedge element for securely locking the pipe attachment in position.

Preferably, the wedge has either a plurality of lateral or longitudinal ridges along a surface arranged to contact, in use, an outer surface of the pipe.

Other features of the invention will be apparent from the dependent claims, and the description which follows.

For a better understanding of the invention, and to show how embodiments of the same may be carried into effect, reference will now be made, by way of example, to the accompanying diagrammatic drawings in which:

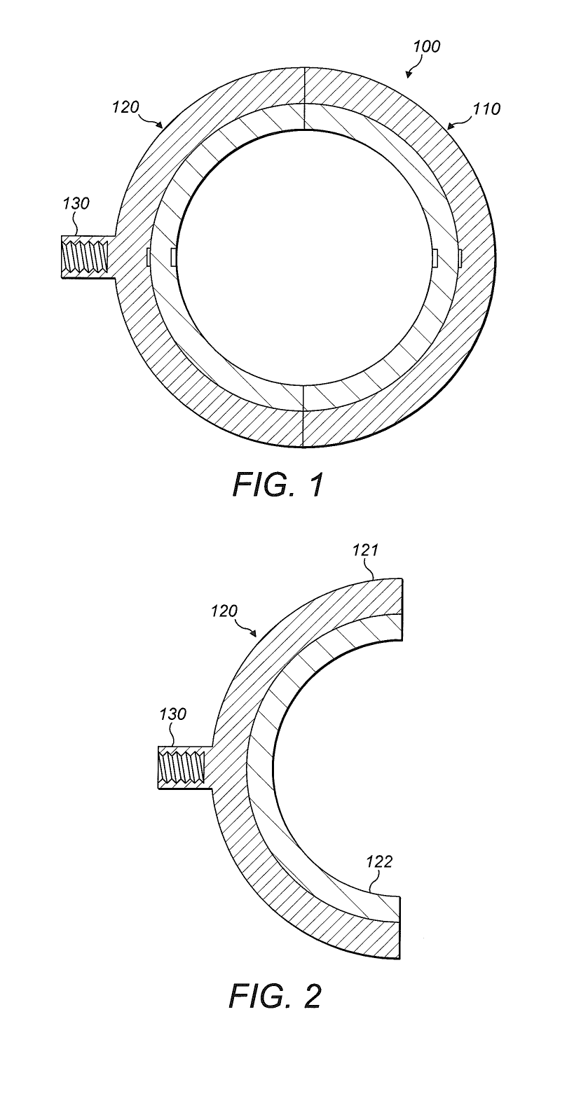

FIG. 1 shows a of a pipe attachment according to an embodiment of the present invention;

FIG. 2 shows one element of the embodiment of FIG. 1;

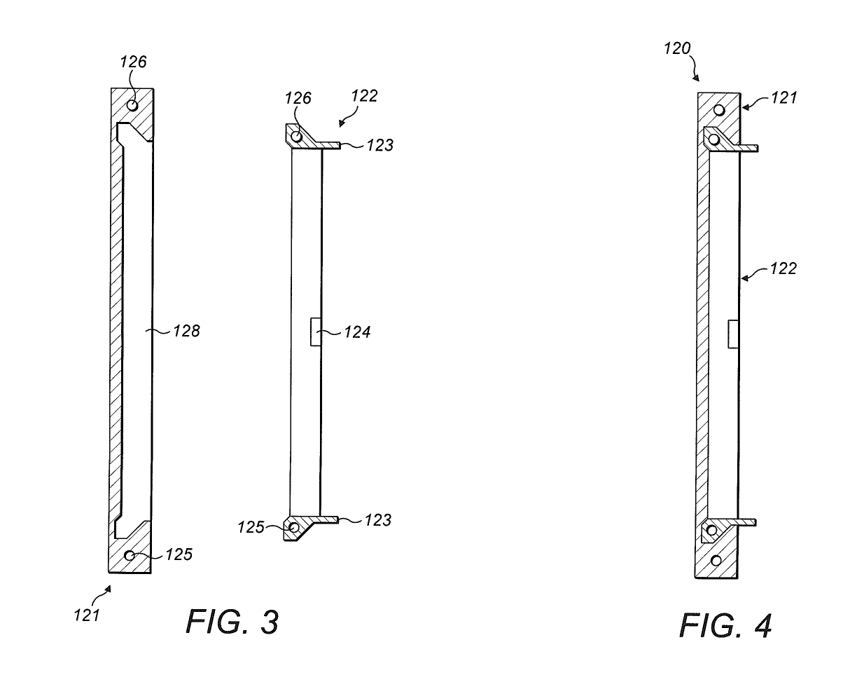

FIG. 3 shows the two sub-elements, which form the element of FIG. 2;

FIG. 4 shows the two sub-elements of FIG. 3 coupled together, ready for use;

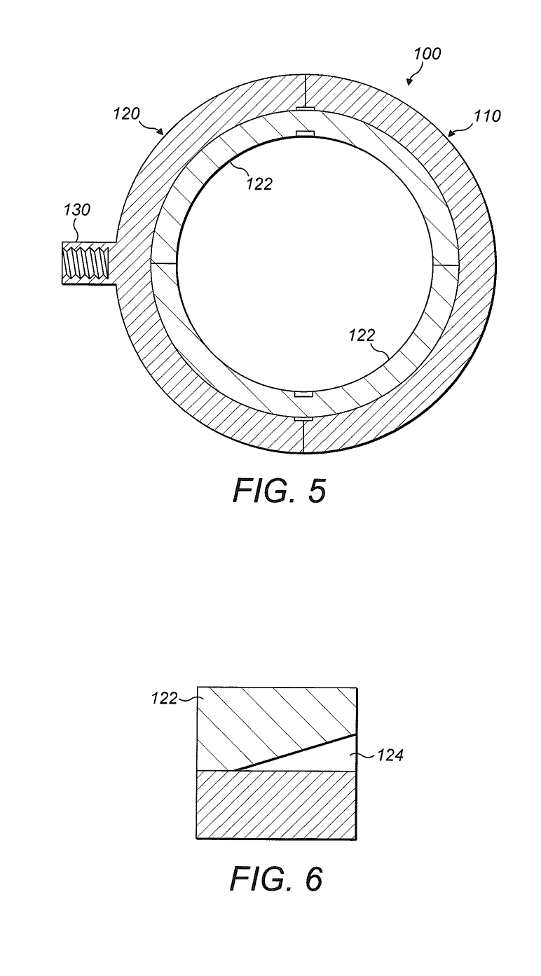

FIG. 5 shows the pipe attachment, in a locked configuration;

FIG. 6 shows a detail of the pipe attachment, used in securing the pipe attachment in position;

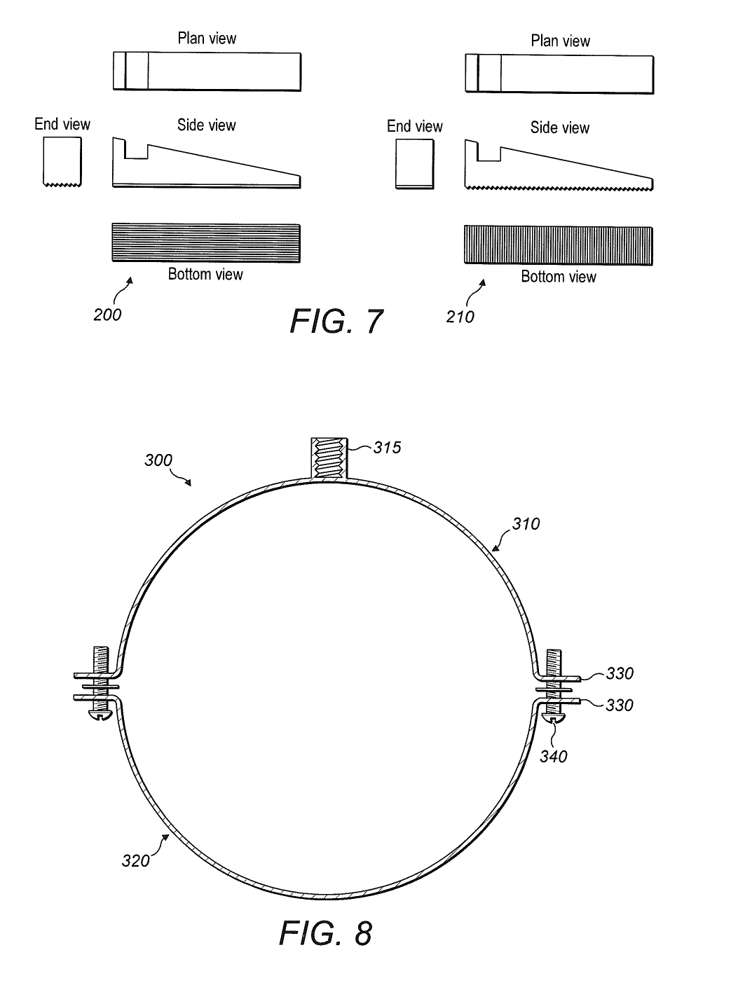

FIG. 7 shows details of a pair of wedge elements used in securing the pipe attachment in position; and

FIG. 8 shows a prior art pipe support clip.

FIG. 1 shows a pipe attachment 100 according to an embodiment of the present invention. The attachment 100 shown here is used as a pipe clip to allow an attached pipe to be suspended from a ceiling.

The attachment 100 comprises two elements 110, 120. Both elements are essentially identical except that element 120 comprises a threaded boss 130, extending from a midpoint. The threaded boss 130 comprises an internal thread arranged to receive a complementary threaded rod for further attachment to the ceiling or other support system. By this means, the pipe attachment is able to support a pipe to which it is coupled.

In the configuration shown in FIG. 1, the two elements 110, 120 are separable. They are, however, arranged to interlock, as will be described in the following description.

FIG. 2 shows element 120, separated from element 110. Element 120 comprises an outer sub-element 120 and an inner sub-element 122. These are separable from each other as shown in FIG. 3. Outer sub element 121 is semi-circular in shape, and comprises a channel 128, in which is situated inner sub-element 122. The channel 128 is shaped to complement the inner sub element 122 and is arranged such that once inner sub-element 122 is inserted into the channel, it is retained.

To insert inner sub-element 122, it is fed into one end of the channel 128 and then rotated through 180° so that the respective ends of the channel and the inner sub element are aligned, as shown in FIG. 2. The inner sub-element 122 is freely rotatable within the channel. This is key to locking together elements 121, 122 as will be described shortly.

Extending from the inner sub-element 122 are a pair of tabs 123. These are arranged such that, in use, they extend axially and rest on an outer surface of the pipe to which the attachment 100 is attached. These are provided to allow easy rotation of the inner sub-element 122 relative to the outer sub-element 121.

The inner and outer sub-elements comprise alignment features 125, 126 to assist in aligning the elements 120, 121 as they are positioned and interlocked as will be described. Alignment features 125 are raised projections arranged to co-operate with and enter alignment feature 126, which are recesses. When projections 126 enter recesses 125, then correct alignment has been achieved, which assists a user in installing the pipe attachment 100.

Once the inner sub-element 122 is inserted into the channel 128, the completed element 120 is as shown in FIG. 4 (and also as shown in FIG. 2).

The inner and outer sub-elements can be formed from plastics materials, moulded as necessary. In certain alternative configurations, they can be formed from steel or another metal.

It should be noted, that apart from boss 130, element 110 is identical to element 120.

In order to attach the pipe attachment 100 around a pipe, there is no requirement to have access to an end of the pipe. The two elements 110, 120 are placed around opposite sides of the pipe so that their exposed ends meet.

The attachment then resembles the configuration shown in FIG. 1. Once the alignment features 125, 126 are properly engaged, then the user knows that proper alignment has been achieved.

Of course. If the user lets go of the two elements 120, 121, they will simply fall away from the pipe. In order to interlock them so that the attachment 100 remains in position around the pipe, it is necessary to rotate the inner sub-elements 122 relative to the outer sub-elements. This is achieved by using the tabs 123 which extend from the inner sub-elements. By rotating the tabs, so that they follow the outer surface of the pipe, the inner sub-elements 122 of each element rotate relative to their respective outer sub-elements 121. Specifically, one inner sub-element 122 enters channel 128 of the other outer sub-element. Of course, since both inner sub-elements and outer sub-elements are in direct contact, what is happening with one inner sub-elements at one end is happening at the other end of the other sub-element, causing the two elements to become inter-locked and firmly attached to the pipe.

This locked configuration is shown in FIG. 5, which shows the relative orientation of the inner and outer sub-elements once the attachment 100 is locked into position. It shows, by comparison with FIG. 1, that the inner and outer sub-elements, rather than having their respective ends aligned are now rotated by 90° relative to each other. In other words, the inner sub element of one element 110 is now equally engaged with the other element 120, and vice-versa.

In this locked configuration, the pipe attachment is firmly secured around the pipe and will not come apart unless the interlocking process is reversed.

However, in certain situations, the attachment can be subject to vibrations and impulse shocks. This can happen particularly at startup, when a pump is first powered up to pump fluid through the pipe. In order to provide additional security and stability, the inner sub-elements are provided with an angled recess 124 abutting, in use, the surface of the pipe. This recess 124 is shown in FIG. 3 and in more detail in FIG. 6. The recess has a generally wedge-shaped profile and is intended to receive a complementarily shaped wedge element. Two different wedges 200, 210 are shown in FIG. 7.

The wedges are intended to be accommodated in recesses 124. Once the pipe attachment 100 is assembled, one or more wedges 200, 210 can be forcibly inserted into one or more recesses 124 to secure the pipe attachment in position.

Wedge 200 has a plurality of longitudinal ridges along its lower surface. These, in use, will contact the exterior surface of pipe and will prevent the pipe attachment from rotating about the pipe.

Wedge 210 has a plurality of lateral ridges along its lower surface. These, in use, will contact the exterior surface of the pipe and will prevent the pipe attachment from migrating along the pipe.

The wedges 200, 210 are each provided with a removal slot to allow them to be removed simply with a screwdriver. The wedges 200, 210 may be constructed from a material similar or identical to the material used to construct the pipe attachment. In some domestic installations, a plastics material may be suitable, but for larger pipes, the wedges are formed from steel or another suitable metal.

If the pipe attachment need to be removed, then any wedges can be removed by use of the removal slot, and the process for interlocking the two elements can be reversed to allow them to be separated. Then, the two elements simply come away from the pipe.

In the embodiment shown in FIG. 1, where the pipe attachment is of the type used to suspend the pipe from a ceiling, then the boss 130 is first located to point upwards, and then the attachment is fitted as previously described.

Other types of attachment replace the boss with another device appropriate to the task it is required to perform. For instance, if the attachment is required to support cables, then an integrated cable tie can be provided. Other used will be apparent to the skilled person.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A pipe attachment, comprising first and second elements, each comprising an inner sub-element and an outer sub-element, the inner and outer sub-elements being rotatable relative to each other, wherein in a first configuration, the first and second elements are separate and positionable to surround a pipe, and in a second configuration, they are locked together, wherein the locking together is achieved by relative rotation of the respective inner and outer sub-elements such that the inner sub-element of the first element at least partially engages with the outer sub-element of the second element, and the inner sub-element of the second element at least partially engages with the outer sub-element of the first element.

2. The pipe attachment of claim 1 wherein the inner sub-element is retained within a channel in the outer sub-element.

3. The pipe attachment of claim 1, wherein the first element is provided with a coupling device arranged for attachment to a support system.

4. The pipe attachment of claim 3 wherein the coupling device comprises a boss having a threaded interior for coupling to a complementarily threaded rod.

5. The pipe attachment of claim 1 wherein the inner sub-element is provided with an axially extending tab.

6. The pipe attachment of claim 1 wherein the inner sub-element is provided with a recess arranged to receive a wedge element for securely locking the pipe attachment in position.

7. The pipe attachment of claim 6 further comprising a wedge positioned in the recess.

8. The pipe attachment of claim 7 wherein the wedge has either a plurality of lateral or longitudinal ridges along a surface arranged to contact, in use, an outer surface of the pipe.

9. (canceled)
